(19) United States
(12) Patent Application Publication
(10) Pub. No.: US 2010/0311030 A1
(43) Pub. Date: Dec. 9, 2010

(54) USING COMBINED ANSWERS IN MACHINE-BASED EDUCATION

(75) Inventors: Xiaodong He, Issaquah, WA (US); Alejandro Acero, Bellevue, WA (US); Sebastian de la Chica, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/477,138

(22) Filed: Jun. 3, 2009

(51) Int. Cl. G09B 3/00

(52) U.S. Cl. 434/350

(57) ABSTRACT

Described is a technology for learning a foreign language or other subject. Answers (e.g., translations) to questions (e.g., sentences to translate) received from learners are combined into a combined answer that serves as a representative model answer for those learners. The questions also may be provided to machine subsystems to generate machine answers, e.g., machine translators, with those machine answers used in the combined answer. The combined answer is used to evaluate each learner's individual answer. The evaluation may be used to compute profile information that is then fed back for use in selecting further questions, e.g., more difficult sentences as the learners progress. Also described is integrating the platform/technology into a web service.

### BACKGROUND

Foreign language education is highly desirable for many people in many varied circumstances. However, current foreign language learning approaches are usually very constrained, relatively inefficient, and expensive.

For example, in order to learn a foreign language, students usually need to take long classes, with high-quality bilingual teachers needed to teach the course. This is highly inconvenient and/or too expensive for many potential students. Further, independent of the expense, it is often difficult to find adequately skilled foreign language education teachers, especially in small-population areas and/or developing countries. As a result, some students can only learn from teachers who are less skilled, whereby they tend to learn less than students with access to trained native speakers of that foreign language.

Any technology that helps reduce the cost and/or helps improve foreign language education is highly desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which answers (e.g., language translations) to questions (e.g., word sets such as sentences to translate) from learners are combined into a combined answer that serves as a representative model answer for those learners. The questions also may be provided to machine subsystems to generate machine answers, e.g., machine translators, with those machine answers used in the combined answer. The combined answer may then be used to evaluate each learner's individual answer, such as to generate an indication of any errors and a score as to how each learner did. The learners may receive the answers, error data and/or scores to help improve their understanding of a subject, e.g., a foreign language.

Further, the error data and scores may be used to compute profile information that is then fed back into the system for use in selecting further questions. For example as learners progress in their understanding of a subject, more difficult word sets may be provided. In one aspect, the platform/technology may be incorporated into a web service.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components in a platform that uses combined answers for educating learners.

FIG. 2 is a flow diagram showing example steps used in using combined answers for educating learners.

FIG. 3 shows an illustrative example of a computing environment into which various aspects of the present invention may be incorporated.

### DETAILED DESCRIPTION

Various aspects of the technology described herein are generally directed towards enabling and improving computer-assisted learning scenarios using a machine-based platform. In general, the technology is based upon aligning and combining the answers/results (e.g., foreign language translations) from learners and possibly also multiple machine translation systems, which results in a single translation of higher quality than any individual learners or automated (and potentially suboptimal or weak) machine translation systems. In general, for example, individual language learners (students) act as if each is a “machine translation subsystem” to collectively generate a best-possible translation that can be used as the de-facto “gold standard” in peer-learning settings. This gold standard translation may then be used to evaluate the answers provided by the individual students so as to generate appropriate feedback.

It should be understood that any of the examples herein are non-limiting. For example, an alternative is to use the technology to improve a first language rather than a foreign language, or to learn another area of expertise. Further, the technology may be generalized to the idea of generating common ground across answers to questions (i.e., not just questions and answers regarding translations). As a more particular example, suppose an earth science instructor gives students a question such as “what are divergent plate boundaries?” By collecting and aligning the answers with the technology described herein, a model of student conceptual models about a topic may be generated, which is valuable in education because a teacher may quickly determine the most common conceptions and misconceptions. Similarly this may be extended to crowd-sourcing question-answer problems, where one collects answers to questions provided by a multitude of people and then generates a “gold-standard” answer. These need not be students, for example, but testing experts who use the technology to develop model answers to test questions; notwithstanding, the term “learner” as used herein is any student or other person who uses the technology to develop an answer.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in machine translation and automated education in general.

It should be noted that with respect to foreign language education, the technology described herein is somewhat more directed towards foreign language education in a second stage, that is, the learning, composing and/or understanding of sentences/paragraphs (or any sets of words such as phrases) in the foreign language, (in contrast to a first stage of learning of vocabulary, pronunciation, and simple grammar). However, in practice, these two stages of learning may interact with each other, and there is no definite boundary between them. As such, the technology may provide benefits in either stage.

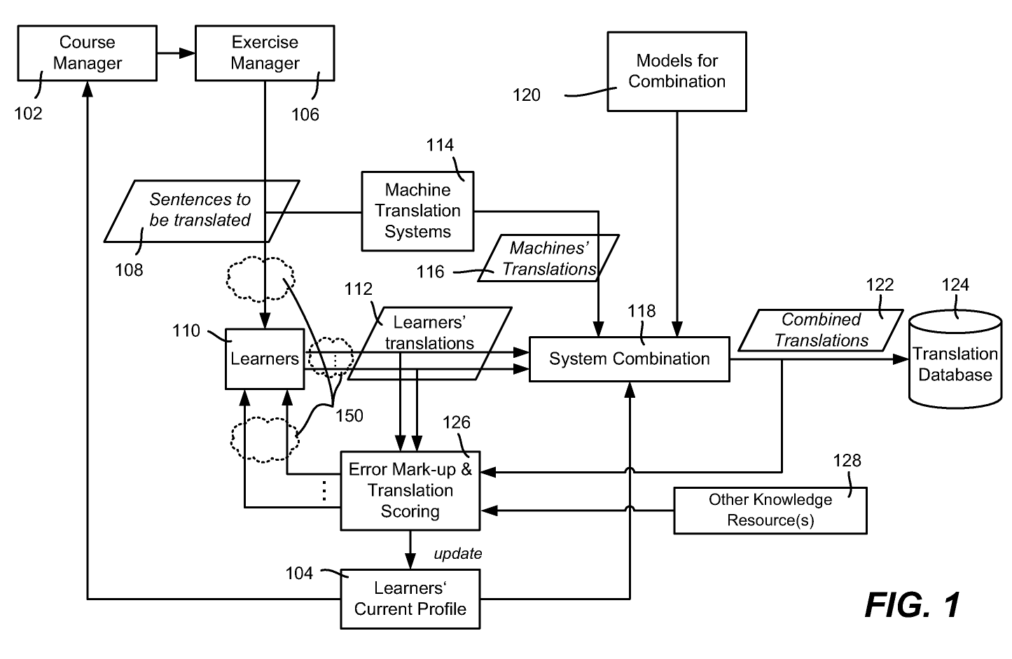

Turning to the drawings, FIG. 1 shows one implementation of a foreign language platform that is in part based on machines but also includes human input. A course manager 102 (e.g., a software module) generally controls the overall progress of the language learning process. For example, based on a current profile 104 of the learners (e.g., students), the course manager 102 asks an exercise manager 106 to generate a translation exercise at an appropriate difficulty level. This may comprise sentences 108 that are to be translated from one language into another, whether from the students' native language to the foreign language to be learned, or the other way around. Note that the tasks of the managers 102 and 106 are typically automated via software modules, but may be performed manually in whole or in part.

The learners (represented by block 110) then do their best to translate these sentences, as represented by the “Learners' Translations” block 112. Note that such translations may also be used to help collect training data.

In addition to being translated by the learners, the sentences 108 also may be fed to one or more machine translation systems 114 for translation, as represented by the “Machines' Translations” block 116. Then both sets of translations 112 and 116 are fed into a system combination module 118.

Using trained system combination models 120, a high-quality combined translation set 122 (e.g., one or more translations, such as one translation for each sentence) are generated, which are then used as references (e.g., the “ground truth” or “gold standard”) of the translation exercise. The answer set also may be collected in a translation database 124, such as used for training data and/or improving the system as described below. Further, as represented by the block 126, the learner translations 112, which are distinctly preserved for each learner, are evaluated against to the combined translation set 122 and scored, with any translation errors identified. In this manner, the students 110 are able to learn from the combined translation set 122, identify their errors and improve their skills.

One or more knowledge resources 128 (e.g., spell checkers, grammar checkers and so forth, such as English as a Second Language or ESL-based resources) may be used to help with the amount of noise introduced by student-generated answers. This is because unlike machine-generated translations, students often produce nonsensical text, misspellings, vocabulary mismatches, convoluted grammar and/or sometimes random results.

As can be seen, one learning loop in FIG. 1 is based upon the students' input to the error mark-up and translation scoring module 126. To “try-and-learn,” students do the translation exercise, and receive the feedback from which they learn from that feedback and improve their skill on that language. The loop starts again for the next translation exercise, and so on, whereby students can gradually learn more and more about the foreign language or other subject.

Another learning loop is based upon the course manager 102, which asks the exercise manager 106 to generate translation exercise at certain difficulty level according to the current profiles 104 of the students. The students do the exercise, and have their results scored, which is then used to update the profiles (including the skill level) of the students. As described above, this is fed back into the course manager 102, where, based on the current students' profiles 104, the course manager 102 estimates the overall progress of the whole course, and adjusts the targeting difficulty level for the next learning exercise.

While the above learning loops may be considered somewhat similar to conventional manual foreign language education techniques, another learning loop is present in this platform, namely a human/machine hybrid learning loop. This loop starts from the students 108, such that each student produces a translation (which may contain errors) for each sentence in the exercise. The system combination module combines these individual translations 112 and the machines' translations 116 to form the combined translation set 122. Each combined translation in the set may then be used as a reference for the error mark-up and translation scoring module 126 that it processes against the individual translation from each student, thereby providing each student with useful feedback.

In the hybrid learning loop, it can be seen that part of any new knowledge that an individual student may learn comes from his or her peers, that is, the reference is an aggregation of the correct parts of translations from different students. From this point of view, this is a “learn-from-peers” scheme, and the platform acts as an agent to aggregate partially correct translations from peers, identify the correct parts, and form a high-quality comprehensive translation reference. Conversely, compared to conventional “learn-from-peers” scenarios, the translations from students have complicated structure and noise errors, and the volume of data needs to be processed is relatively large. Therefore, it is beyond the capability of students to handle, and as such, statistical models and “intelligent” algorithms are used.

Compared to the approach of using machine translation output directly as the translation reference for foreign language education, the human/machine hybrid platform has an advantage in that the quality of the translation reference may dynamically improve along with the progress of the course. As the foreign language skill of students improves, the quality of the combined output (translation reference) keeps improving along with the student's improvement, instead of being limited by the machine translation limitations.

Turning to additional details regarding machine translation and system combination, the underlying combination algorithm (block 118) ordinarily performs much better than just taking the translated sentences from the best student, and ordinarily generates sentences that are better than any single student's translations. In general, the combination algorithm produces a high-quality translation by combining a set of moderate-quality translations generated by weaker or more moderate sub-systems. Beyond student input, the improvement of the combined translation over the translation of the best single system increases with the number of “systems,” and works well when the other systems are of similar quality. Thus, students are one type of sub-system from which the combination technology combines their partially-correct translations to form a high-quality translation, which can be used as the translation “ground truth.” At the same time, one or more computer-based machine translation systems can also be incorporated in this framework to further boost the quality of the “ground truth.”

As is known, machine translation is directed towards the use of computers to translate text or speech from one natural language to another. At one level, machine translation translates word-by-word, like a dictionary look-up. However, most current machine translation technologies handle linguistic typology, phrase, idioms, and so forth at a more complicated level. Although there are various machine translation approaches (e.g., syntax-based, phrase-based, hierarchical structure-based), the concepts are similar. Typically the source sentence is “decomposed” into a set of sub-sentence unit, e.g., phrases or sub-parsing-trees, and these units are translated into corresponding target sub-sentence units by rules/mappings (which could be automatically learned, or manually provided, or a mix of two); the target sub-sentence units are further re-ordered/modified based on statistical models and/or rules in an attempt to form a meaningful and grammatically correct sentence in the target language.

In one implementation, the system combination module 118 is somewhat like a voting scheme among multiple individual systems. However, because decision for language translation tends to be complicated, more sophisticated approaches are used to conduct an effective “voting.” In general, system combination produces a better-quality translation from a set of moderate-quality translation hypotheses.

To this end, hypotheses from multiple individual machine translation systems and learners are collected. Then the hypotheses are aligned at the word-level to form a confusion network, comprising a sequence of alternative sets in which each word is aligned to a list of alternative words (including null words) in the same set. In a hypothesis alignment process, the words of hypotheses are reordered so that semantically similar words are aligned together, and the overall word order is more fluent and follow the grammar better. Thereafter, global and local features are used to decode the confusion network to produce the final combined output, which is formed by picking one word from each alternative set.

Sometimes the algorithm selects the translation from among the multiple hypotheses, while sometimes it composes a translation that is better than the best hypotheses from any of the individual subsystems (machines or learners). Note that the best hypotheses are not always from the same subsystem. One suitable implementation uses an alignment-based system combination algorithm as described in the publication by He et al., EMNLP 2008, available at http://research.microsoft.com/˜xiaohe/publication/he_emnIp08_final.pdf, which is hereby incorporated by reference.

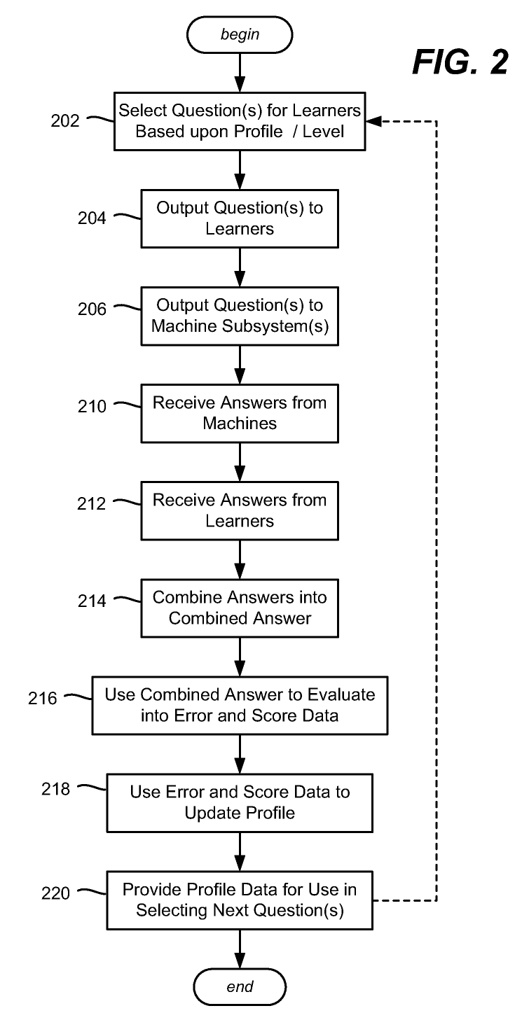

FIG. 2 summarizes the various example steps in one implementation, beginning at step 202 which represents selecting the questions (e.g., word set or sets) to provide to learners. As described above, this is generally based on the profile data so that learners receive questions at an appropriate level based on their skill. Step 204 outputs the questions to the learners, and step 206 outputs the questions to the machine subsystems, e.g., machine translation systems.

Steps 210 and 212 represent receiving the machine and learner answers (e.g., translations), respectively. Note that some time may lapse while waiting for the learners to provide the answers, and indeed, the process may limit how long a learner can take before taking further action, so as to not delay other learners in obtaining their results. For example, a learner that takes too long may be treated as if that learner was absent, with possibly a hint provided once the combined answer was determined.

Step 214 represents the combining of the answers into the combined answer. This combined (e.g., model) answer is provided for use in evaluating (step 216) how each learner did. The answer may also be collected along with other data for other uses, e.g., model and/or machine translator training. At this time, (or at a later time determined by the instructor, for example, such as after a series of questions and answers are completed), the learner can see the results.

Step 218 represents building/updating the profile data for the learners based on the results. At step 220 this data is provided back to the questioning mechanism (e.g., the course manager component) for use in selecting questions at an easier or more difficult level depending on how the learners did, as indicated by the dashed line back to step 202. Note that step 220 may be performed after each question and answer or after a series of questions and answers.

Turning to another aspect, in general, the more sub-systems (students and machines) that are combined the higher the quality of the combined output tends to be. Therefore, it may be beneficial to extend the platform to web-scale via a foreign language education service, essentially providing an online foreign language learning community. This is represented in FIG. 1 in which the students communicate with the system via a “cloud” connection, (shown as dashed clouds 150 to indicate it is one optional way to implement the platform).

However, unlike students in the same class, different web users may have very different levels of skill of a given foreign language, and therefore the users that have similar scores should be assigned into a same learning group. Further, users in a learning group may change frequently, as web users are often less committed and tend to have more flexible schedules. In such events, the system combination algorithm may be adapted accordingly.

Users thus register with the web service so that the service can track each user's progress and adjust the course for each dynamically according to any particular needs. Users may also communicate with to each other and help each other. In addition, users may transfer to another more appropriate-level group after a certain time so as to increase the diversity, and learn from new peers.

Moreover, by providing such a service and community, a large amount of valuable data may be collected. These data include the source and reference sentences (e.g., as pairs) that appear in the translation exercise, the translation error patterns for language learners at different levels, the language learning behavior of users, the easy and difficult parts in the language learning process, and so forth. These data may then be used to help improve machine translation technologies, improve other mechanisms such as a grammar checker, and improve the service itself.

As can be seen, the platform facilitates various educational scenarios, including formative assessment of translation activities in social language learning situations, and assessment of conceptual knowledge understanding. With respect to formative assessment of translation activities, an instructor in a language learning course may assign an activity to students in the form of a collection of translation sentences to be submitted. As the students provide their answers (e.g., online) the technology automatically identifies the “correct” answer by using the align-and-combine approach. In this manner, students may receive incremental feedback as to the correctness of their translations in near real-time as they finish translating each sentence. This incremental feedback scenario provides the student with the opportunity to engage in self-directed or guided remedial work without having to wait until the instructor has time to grade everyone's exercises. Moreover, students have the opportunity to improve as they complete the set of sentence translations required in the exercise, as opposed to having to wait until the instructor receives and grades everyone's exercise, which may be too late to support effective learning for some learners.

In addition, the instructor or an educational institution (i.e., a possibly distant learning institute) may create an activity that allows the students themselves to come up with their own translation exercises to share with the rest of the students (which may be in an anonymous manner). In such peer learning situations, the instructor monitors the translation exercises being generated while allowing the students to explore the vocabulary space in the language being learned. The automated assessment of the student submissions is performed with little or no instructor intervention, which is advantageous over existing social foreign language learning systems because the invention may be employed and utilized without the need for a tutor or instructor to proactively assess and provide feedback to each student participating in the social network. An end-result is a highly-scalable social foreign language learning network.

With respect to the assessment of conceptual knowledge understanding, the technology may serve as an enabler of differentiated education. In general, improved learning occurs when teachers can adapt the materials and pedagogical strategies to match the students. If teachers recognize the different conceptual understandings students may hold regarding a particular topic, teachers can target groups of students holding similar, but faulty, conceptual understandings.

By way of example, an instructor in an Earth science course may provide students with a collection of short-answer questions targeting key concepts, e.g., the concept of divergent plate boundaries. Students submit their answers, and the platform may align the answers to establish which groups of answers appear to be most closely related, in essence generating clusters of answer sets that communicate one particular understanding. The combining technology may then summarize how each cluster of students appears to understand the concept of divergent plate boundaries. With this information, the instructor may identify any typical misconceptions within any group, and prepare alternative or revised strategies, without having to read every student's answer to the question.

In the example of divergent plate boundaries, two groups may emerge, such as one group that correctly understood that divergent plates move away from each other, with the other group having mistakenly expressed that such plates move towards each other. The instructor may then take appropriate action (e.g., send an email with suggested learning resources explaining the different types of boundaries) with respect to the students who appear to misunderstand the concept, without burdening the other students.

### Exemplary Operating Environment

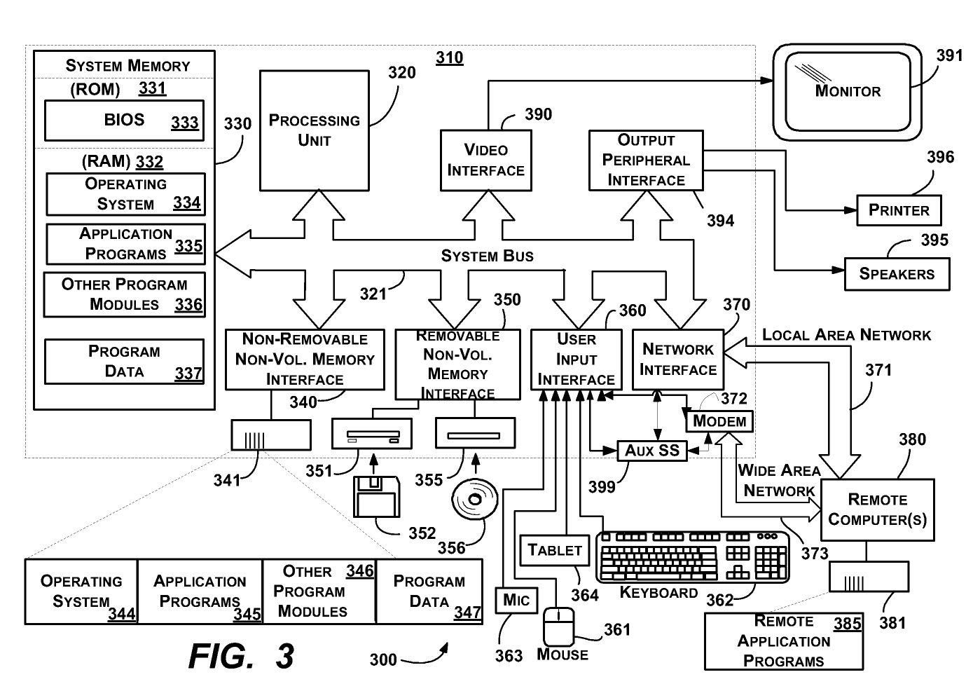

FIG. 3 illustrates an example of a suitable computing and networking environment 300 into which the examples and implementations of any of FIGS. 1-2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, receiving answers based on questions provided to learners, combining the answers from the learners into a combined answer set, and using the combined answer set to evaluate the answers of the learners.

2. The method of claim 1 wherein the questions correspond to a word set, wherein the learners' answers correspond to a translation of the word set, and further comprising providing the questions to at least one machine translation subsystem, receiving a translation from each machine translation subsystem, and combining the answers from the learners with the translation from each machine translation subsystem into the combined answer set.

3. The method of claim 1 further comprising providing the questions to at least one machine subsystem, receiving a machine answer from each machine subsystem, and combining the answers from the learners with the machine answers from each machine subsystem into the combined answer set.

4. The method of claim 1 wherein combining the answers includes generating a plurality of hypotheses, and aligning the hypotheses at a word-level.

5. The method of claim 1 wherein using the combined answers to evaluate the answers of the learners comprises indicating any error data and providing a score for each learner.

6. The method of claim 5 further comprising, making accessible the error data and score to each learner.

7. The method of claim 5 further comprising, maintaining the error data and the score for a plurality of users in as profile information.

8. The method of claim 7 further comprising, using the profile information to adjust a question difficulty level for subsequently providing different questions to the learners.

9. In a computing environment, a system comprising, a question mechanism that provides a word set to learners and to at least one machine subsystem, a system combination module that receives translations of the word set from the learners and each machine subsystem and combines the translations into a combined translation set, and an error detection and scoring mechanism that receives the combined translation set and the learners' translations, and provides data indicative of any errors and a score based upon an evaluation of each learner's translation relative to the combined translation set.

10. The system of claim 9 wherein the system is incorporated into a web service, and wherein the learners receive the word set and provide the translations via a cloud connection to the web service.

11. The system of claim 9 wherein the question mechanism comprises a course manager that determines a level of questioning, and an exercise manager that provides the word set based upon the level of questioning.

12. The system of claim 9 wherein the word set comprises a word, a sentence, a phrase or a paragraph, or any combination of a word, a sentence, a phrase or a paragraph.

13. The system of claim 9 further comprising at least one other knowledge resource that is used by or in conjunction with the error detection and scoring mechanism.

14. The system of claim 9 further comprising a translation database that collects the combined translation set as collected data.

15. The system of claim 9 wherein the error detection and scoring mechanism provides the data indicative of any errors and the score for each learner to that learner.

16. The system of claim 9 wherein the error detection and scoring mechanism provides the data indicative of any errors and the score for each learner for use in updating profile data that is used by the question mechanism in selecting other word sets for providing to the learners.

17. One or more computer-readable media having computer-executable instructions, which when executed perform steps, comprising:
outputting a word set to learners;
receiving a translation to the question from each learner;
combining the translations from the learners into a combined translation set; and
using the combined answer set to evaluate the translations of the learners.

18. The one or more computer-readable media of claim 17 having further computer-executable instructions comprising outputting the word set to at least one machine translation subsystem, receiving a machine translation from each machine translation subsystem, and combining the translations from the learners with the machine translation from each machine subsystem into the combined translation set.

19. The one or more computer-readable media of claim 17 wherein using the combined answer set to evaluate the translations comprises indicating any errors and providing a translation score for each learner.

20. The one or more computer-readable media of claim 17 wherein using the combined answer set to evaluate the translations comprises computing profile information based upon the combined answer set and the translations, and profile information to determine at least one other word set subsequently provided to the learners.
